(19) United States
(12) Patent Application Publication
(10) Pub. No.: US 2022/0009123 A1
(43) Pub. Date: Jan. 13, 2022

(54) Roof Truss Assembly System

(71) Applicant: Christian G. Troyer, Lott, TX (US)

(72) Inventor: Christian G. Troyer, Lott, TX (US)

(21) Appl. No.: 17/370,906

(22) Filed: Jul. 8, 2021

Related U.S. Application Data
(60) Provisional application No. 63/050,092, filed on Jul. 9, 2020.

(51) Int. Cl. B27F 7/15; E04C 3/17; B23Q 16/00

(52) U.S. Cl. CPC B27F 7/155; B23Q 16/001; E04C 3/17

(57) ABSTRACT

A roof truss assembly system comprised of multiple moveable pedestals, some of which are mounted on a floor track, and also including roller lift assemblies for lifting and moving a completed roof truss off the top of the assembly system components for subsequent storage or transport.

### PRIORITY CLAIM

This application claims priority to U.S. Provisional Application No. 63/050,092 filed on Jul. 9, 2020, which is hereby incorporated by reference.

### TECHNICAL FIELD OF THE INVENTION

The present invention is generally directed to methods and systems for building and constructing roof trusses.

### BACKGROUND OF THE INVENTION

In the construction industry, manufactured roof trusses are used in the construction of houses, apartments, offices, garages, and many other types of commercial and residential buildings and structures. The manufactured roof trusses are pre-built/assembled before they are delivered to construction sites for use in constructing the roofs of the overall structures that are being built at the construction sites. Manufactured roof trusses are typically, though not uniformly, triangular in shape and they typically have a top portion, a bottom portion, and outside edges.

A standard manufactured roof truss is comprised of several longer boards that are called chords, and several shorter boards that are part of the web. The top portion of the standard manufactured roof truss is comprised of top chords that span what will be the top part of a completed structure's roof, while the bottom portion is comprised of bottom chords that span what will be the bottom part of the completed structure's roof. The top chords and bottom chords of the manufactured roof truss are interconnected to each other by the shorter web boards that link the top chords and bottom chords. The top chords and bottom chords are typically also joined together at the outer edges of the manufactured roof truss that will typically roughly correspond to the outer edges of the completed structure in which the roof trusses are incorporated. Typically the top chords, bottom chords, and web boards are all joined together at their joints (places where the boards intersect each other) by means of truss plates that are hammered and/or pressed into both sides of the boards at the joints to hold all of the boards of the manufactured roof truss together. While there are variations on the various interrelationships, shapes, and components used in the building of manufactured roof trusses, the basic terms and typical structures described above will be well understood by a person of ordinary skill in the art of constructing manufactured roof trusses.

Large-sized roof trusses are typically assembled in large manufacturing plants or big workshops using very large gantry type systems or large, permanently affixed work tables with manually set jigs for positioning individual boards such as top chords, bottom chords, and interconnecting web boards, before those boards are joined together to form a manufactured roof truss by means of multiple truss plates that are hammered and/or pressed into the boards at the joint locations. Such large gantry systems or large work tables are often not practical for use in constructing small to moderate size manufactured roof trusses, and such large systems or tables require a large space for operation. Such large systems are also frequently much less flexible in terms of rearranging in order to switch from construction of one type of roof truss assembly to a different type of roof truss assembly in which trusses of different size and shape must be built using different sized chord and web boards. And while there are automated systems that exist for re-positioning jigs on large work tables to different configurations, such automated systems are typically prohibitively expensive for small to moderate size manufacturers. What is needed is a relatively inexpensive system that can be quickly assembled, disassembled, and re-assembled while capable of use in a smaller space for construction of manufactured roof trusses.

### SUMMARY OF THE INVENTION

The present invention is a roof truss assembly system that involves using multiple moveable pedestals, some of which are track-mounted pedestals that are repositionable at different locations along a linear length of stationary floor track, and others of which are independent pedestals that are totally independent of the stationary floor track and are completely repositionable at varying locations on either side of the track-mounted pedestals and the stationary floor track. Each of the moveable pedestals of the system, whether track-mounted pedestals attached to the floor track, or the repositionable, independent pedestals that are independent of the stationary floor track, will cooperate to provide a repositionable jig system at their tops. The tops of the pedestals are comprised of two elongate, parallel arm members and one or more perpendicularly positioned cross member. The two parallel arm members do not move and are affixed to tops of leg members of their respective pedestal, but the cross members may be moved and temporarily connected between the arm members to provide a variety of positions for jig placement at the top of the pedestals. Since the pedestals themselves are moveable, the cross members at the tops of the pedestals are repositionable in relation to the arm members, and the jigs themselves may be temporarily inserted and connected at various locations on the arm members and cross members of the pedestals, various placements/configurations of jigs are possible when using the roof truss assembly system for construction of varying shapes, geometries, and sizes of manufactured roof trusses.

The roof truss assembly system also features a multiplicity of rollers that may be pneumatically, hydraulically, or mechanically raised or lowered above or below the tops of the pedestals in order to facilitate moving a completed, manufactured roof truss off of the tops of the pedestals once the construction of the roof truss is complete. The rollers allow a completed roof truss to simply be rolled off the tops of the pedestals so that it can be stacked for shipment to a customer or storage. Some of the rollers will be part of, or mounted on, the track-mounted pedestals, while other rollers may be part of the independent pedestals in some embodiments. However, more frequently the system will primarily include rollers that are attached to the track-mounted pedestals rather than rollers that are mounted on the independent pedestals. The roof truss assembly system will also typically include one or more separate, moveable pipe roller assemblies that are freely repositionable as desired at any location in relation to the floor track, the track-mounted pedestals, and the independent pedestals. These pipe roller assemblies' function is to assist in the lifting and rolling off of the completed, manufactured roof trusses from the top of the roof truss assembly system.

A more thorough understanding of the roof truss assembly system and its components and subassemblies can be obtained from a review of the appended drawings and the following description provided below corresponding to those drawings.

### BRIEF DESCRIPTION OF THE DRAWINGS

The following description is to be read in conjunction with the identified drawing figures that are included as a part of this patent application.

FIG. 1 is a side view of an embodiment of a track-mounted pedestal that is one of the components of the roof truss assembly system.

FIG. 2 is a side view of an embodiment of a track-mounted pedestal that is one of the components of the roof truss assembly system.

FIG. 3 is a front view of an embodiment of a track-mounted pedestal that is one of the components of the roof truss assembly system.

FIG. 4 is a top view of an embodiment of a track-mounted pedestal that is one of the components of the roof truss assembly system.

FIG. 5 is a perspective view of one embodiment of a track-mounted pedestal of the assembly system.

FIG. 6 is a perspective view of another embodiment of a track-mounted pedestal of the assembly system showing additional features.

FIG. 7 is a top view of a subassembly of the assembly system that is comprised of multiple track-mounted pedestals located at different positions along a stationary track.

FIG. 8 is a side view of an embodiment of the track-mounted pedestal that is shown as mounted on a stationary track showing additional features.

FIG. 9 is a side view of an embodiment of an independent pedestal that is one of the components of the roof truss assembly system.

FIG. 10 is a front view of an embodiment of an independent pedestal that is one of the components of the roof truss assembly system.

FIG. 11 is a perspective view of one embodiment of an independent pedestal of the assembly system.

FIG. 12 is a perspective view of another embodiment of an independent pedestal of the assembly system.

FIG. 13 is a side view of an embodiment of a pipe roller assembly, which is one of the components of the roof truss assembly system.

FIG. 14 is a perspective view of an embodiment of a pipe roller assembly, which is one of the components of the roof truss assembly system.

FIG. 15 is a front view of an embodiment of a pipe roller assembly, which is one of the components of the roof truss assembly system.

FIG. 16 is a perspective view of one embodiment of the roof truss assembly system in which the workpiece, which is a roof truss under construction, is positioned on top of multiple pedestals.

FIG. 17 is a top view of one embodiment of the roof truss assembly system in which multiple components and a subassembly of the system comprised of multiple track-mounted pedestals are illustrated.

FIG. 18 is the same top view of the embodiment of the roof truss assembly system previously shown in FIG. 17, except that FIG. 18 also includes an illustration of the workpiece, which is a roof truss under construction, positioned on top of the components and the subassembly previously illustrated.

FIG. 19 is a perspective view of one embodiment of the roof truss assembly system showing components and a subassembly of the system with the workpiece positioned on top of the embodiment of the system.

FIG. 20 is another perspective view of an embodiment of the roof truss assembly system showing components and a subassembly of the system with the workpiece positioned on top of the embodiment of the system.

FIG. 21 is another perspective view of an embodiment of the roof truss assembly system showing a component and a subassembly of the system with the workpiece positioned on top of the embodiment of the system.

FIG. 22 is another perspective view of an embodiment of the roof truss assembly system showing a component and a subassembly of the system with the workpiece positioned on top of the embodiment of the system.

FIG. 23 is another perspective view of an embodiment of the roof truss assembly system showing components and a subassembly of the system with the workpiece positioned on top of the embodiment of the system.

### DETAILED DESCRIPTION OF THE EMBODIMENTS OF THE INVENTION

As discussed above in the summary section, embodiments of the roof truss assembly system disclosed herein are comprised of multiple moveable pedestals of two main types and also moveable pipe roller assemblies, all of which cooperate to provide a repositionable jig system whereon a roof truss can be assembled in a desired shape and size using chord and web boards that are held in a desired geometric alignment during assembly operations by the repositionable jigs. In most embodiments the system is comprised of multiple track-mounted pedestals that can be moved to various positions along a linear, stationary floor track and then temporarily locked into desired positions along the floor track while they are in use for building the roof truss(es). The multiple track-mounted pedestals and the floor track on which they are positioned can be viewed as a subassembly of the overall roof truss assembly system. In most embodiments the system also includes one or more independent pedestals and one or more pipe roller assemblies. The independent pedestals and pipe roller assemblies are not necessarily in contact with the stationary floor track, and if desired, they can be moved to various locations away from the floor track where they may be temporarily positioned for use in constructing and/or lifting the roof truss(es) that are the workpiece of the invention.

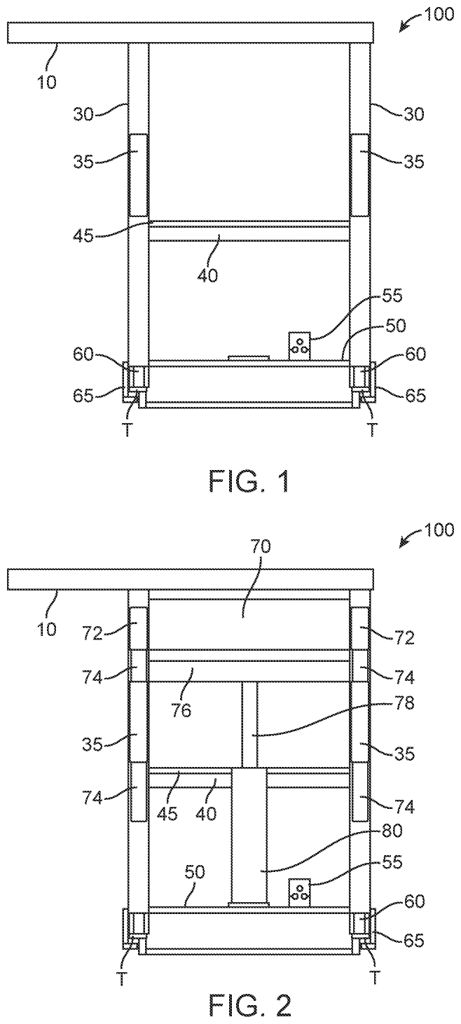

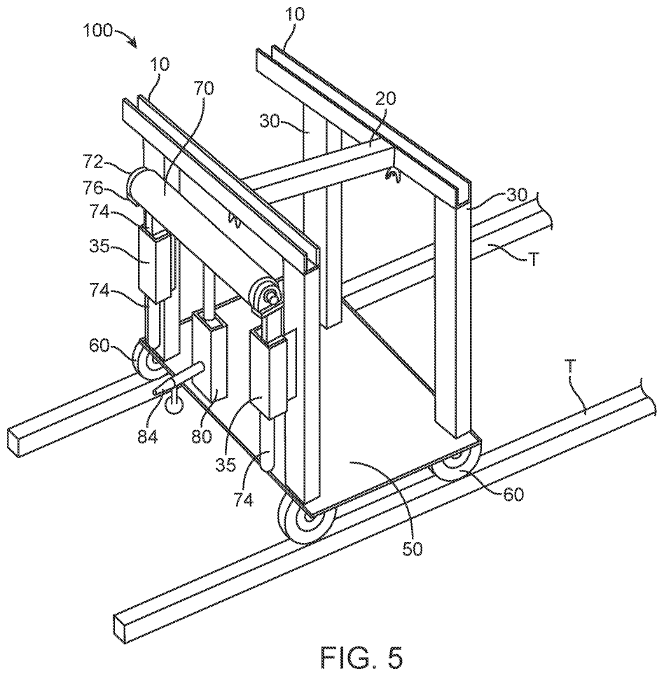

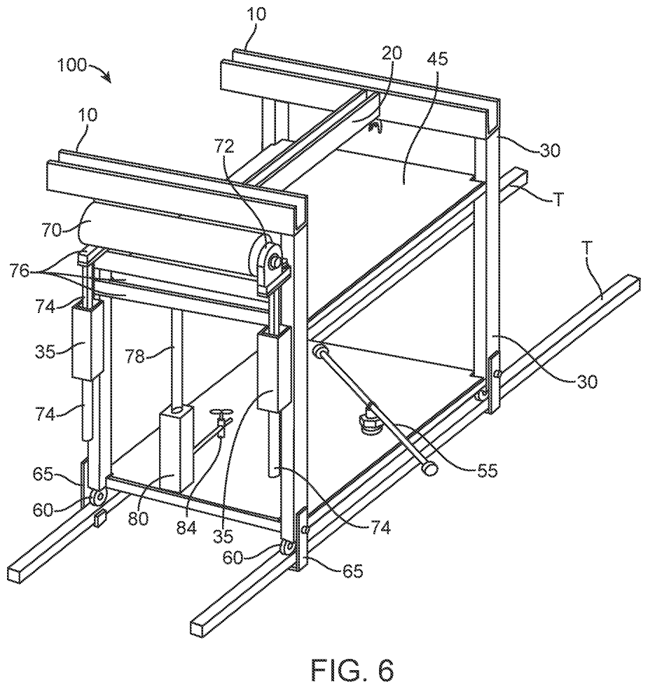

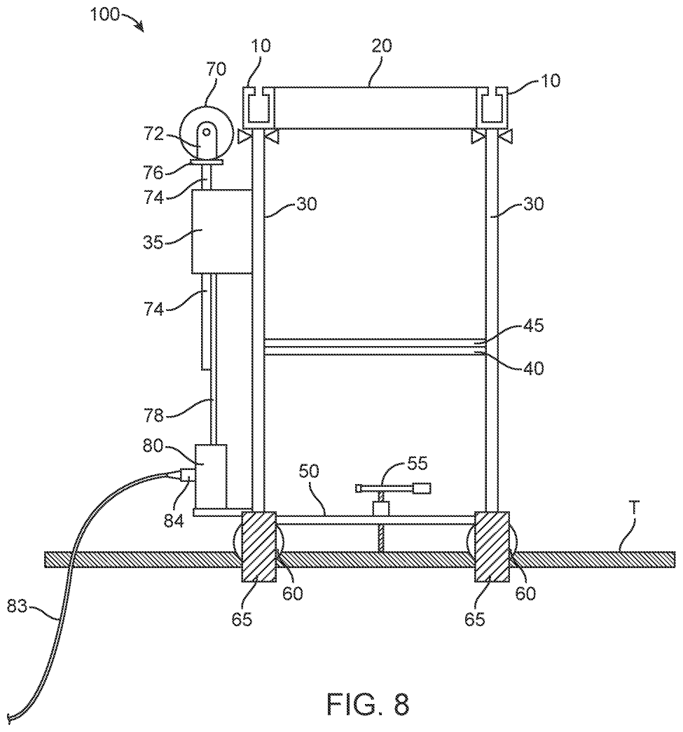

FIGS. 1-6 and FIG. 8 illustrate various embodiments of a track-mounted pedestal 100 that is a part of respective embodiments the overall roof truss assembly system. As illustrated in FIGS. 1-6, the track-mounted pedestal 100 is a generally cart-like structure. The top portion of the track-mounted pedestal 100 features two rigid, elongate, parallel arm members 10, each of which will be horizontal to the floor, and each of which is rigidly affixed to the tops of two of the pedestal's four leg members 30. The four leg members 30 extend vertically downward from the positions where they are rigidly connected to the arm members 20 toward the floor below. Each of the leg members 30 is connected at its bottom end to a track wheel 60 that is rollingly engaged with a linear, stationary floor track T. The leg members 30 are also connected to a base plate 50 that is positioned near the bottom of the pedestal 100 but above the four track wheels 60. The leg members 30 are further connected to shelf support members 40 that support a flat shelf 45 that is located intermediate the base plate 50 and the arm members 10. In most embodiments, the track-mounted pedestals will also feature a repositionable cross member 20 that can be perpendicularly positioned at various locations between the two arm members 10 and can be temporarily connected in a position that is desired for roof truss assembly operations. The system also features a multiplicity of repositionable jigs 22 that may be temporarily connected in desired locations along the lengths of the arm members 10 and/or cross members 20 that are located at the tops of the track-mounted pedestals 100. The jigs 22 are what will be used to hold the chord boards and web boards in a desired geometric alignment during assembly of truss(es).

Most embodiments of the track-mounted pedestal 100 will further include a roller lift 70 that may be used in cooperation with other roller lifts 70 that are attached to other track-mounted pedestals 100 in order to lift a completed, manufactured roof truss up and off of the arm members 10 and cross members 20 of the multiple moveable pedestals and also above the various jigs 22 located on those arm members 10, 20 following assembly of the truss in order to then be able to roll the completed truss off the assembly system for subsequent storage or transport. As shown in FIGS. 2, 3, 5, 6, and 8 the roller lift 70 is attached to the track-mounted pedestal 100 and it is supported on each end by roller supports 72 which themselves are supported by a roller support base 76. The roller lift 70 is rotatably mounted within the roller supports 72 such that the roller lift 70 may rotate or “roll” when the trusses have been completed and are being removed from the top of the assembly system. The roller support base 76 is positioned on top of, and is connected to, the top of a roller piston 78 that may be moved upward or downward by a roller assembly actuator 80 that is mounted on top of the base plate 50 below. The upward and downward movement of the roller lift 70 is guided by two sliding rods 74, each of which depends from an edge of the roller support base 76 and each of which is also slidingly disposed within a tube keeper 35. Each of the tube keepers 35 is connected to a leg member 30 below the level of the roller support base 76. The sliding rods 74 move up or down within the tube keepers 35 depending on whether the roller assembly actuator 80 is moving the roller piston 78 upward or downward.

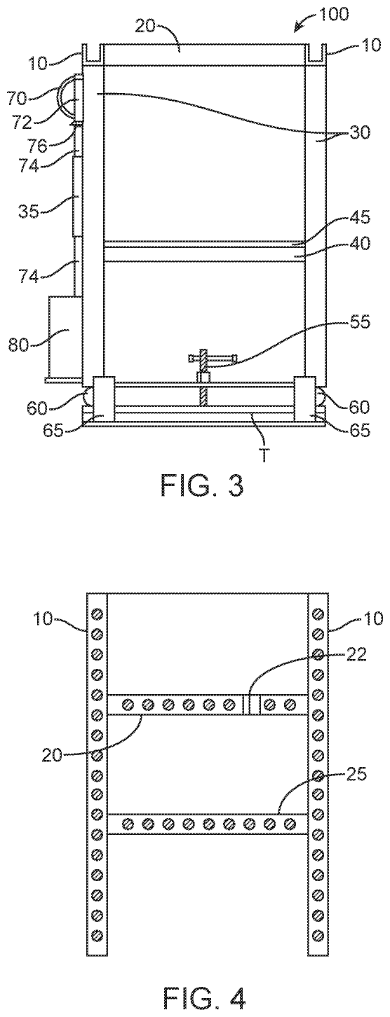

As shown in FIGS. 3-6 and FIG. 8, and as previously discussed, the top portion of the track-mounted pedestal 100 features the two, rigid, parallel arm members 10 and will normally also feature a repositionable cross member 20 that will be detachably connected to, and positioned perpendicular to, the two arm members 10 in a desired location. The track-mounted pedestal 100 may also feature one or more supplemental cross members 25 that are parallel to the first cross member 20. The cross member 20 and any supplemental cross member 25 may be moved into a desired position in relation to the arm members 10 and detachably connected to the arm members 10 by detachable connection means, such as bolts, screws, nuts, pins, or clamps. Once the cross member 20 and/or supplemental cross member 25 are connected in the desired positions between the arm members 10, one or more jigs 22 may be placed and detachably connected to the arm members 10, cross member 20, or supplemental cross member 25 in whatever locations are desired for their later use in positioning of the chord boards and web boards for roof truss assembly operations.

As shown in FIGS. 1-6 and FIG. 8, each track-mounted pedestal 100 features track wheels 60 that are located below the base plate 50, with a track wheel 60 being generally connected to the track-mounted pedestal 100 at the bottom of each of the leg members 30. In some embodiments the track-mounted pedestal 100 is also guided along the stationary floor track T by means of track guides 65 that are connected to the bottoms of the leg members 30 so that the wheels 60 are maintained in rolling contact with the stationary floor track T by the track guides 65 at all times and therefore do not derail during movement along the track T. In some embodiments the track-mounted pedestal 100 will also feature a rod lock 55 that is a means of temporarily locking the track-mounted pedestal 100 in a desired location on the track T while roof truss assembly operations are occurring. The rod lock 55 can be replaced with many different types of temporary locking mechanism, but the simplest is a screw-down bolt type of rod lock 55 that can be used to force a screw into abutment with either the floor surface below or the top surface of the rails of the floor track T below.

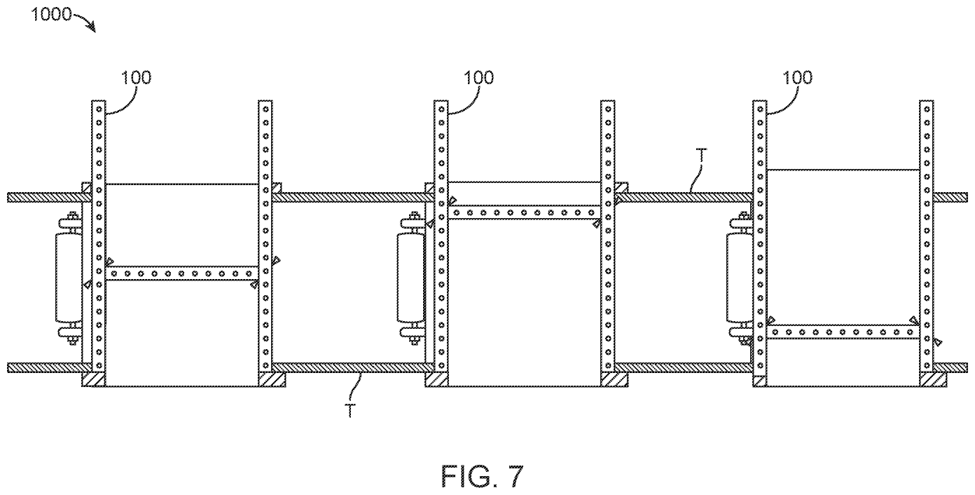

As illustrated in FIG. 7, multiple track-mounted pedestals 100, and the stationary floor track T on which they are rollingly mounted, cooperate to form a floor-track subassembly 1000 of the overall roof truss assembly system. As can be understood when viewing FIG. 7, the track-mounted pedestals 100 are movable along the length of the more or less linear floor track T that is securely affixed or mounted to the floor of a workshop or manufacturing facility for roof truss assembly operations. The track-mounted pedestals 100 may be moved to any desired position along the length of the floor track T using repositioning means located at the bottom of the pedestals—such as the track wheels 60 illustrated in FIGS. 4-6. Such repositioning means could also be caster wheels, a tracked-vehicle type apparatus, a multiplicity of ball bearings, etc. The track-mounted pedestals 100 can then be temporarily and reversibly locked and held in place at a desired position along the length of the floor track T by means located at the bottom portion of the track-mounted pedestals 100, such as the rod locks 50 previously discussed. Such rod locks 50 could potentially be replaced with screws, bolts, clamps, other types of locks, rods, pins, etc., so long as temporary locking and holding in a desired position are made possible.

As can be understood when viewing FIG. 7, the arm members 10, cross members 20, and supplemental cross members 25 of multiple track-mounted pedestals 100 will cooperate to provide multiple, potential, temporary attachment points for one or more jigs 22 to be attached at various desired locations at the top of the track-mounted pedestals 100 for positioning of the boards of a roof truss during the manufacturing process. The one or more jigs 22 may be attached, detached, and reattached in different locations at the top of the various track-mounted pedestals 100 such that both the track-mounted pedestals 100 and the jigs 22 themselves are reconfigurable into various positions allowing for chord boards and web boards of varying shapes, compositions, and sizes to be positioned as desired during assembly of the trusses.

In a preferred embodiment, the track-mounted pedestals 100 that comprise the floor-track subassembly 1000 are made of heavy duty square tubes and steel plates so that they are extremely rigid and stable. In the preferred embodiment, the track-mounted pedestals 100 are installed on a straight floor track T having two rails that is securely mounted to the floor of a workshop or manufacturing plant. In the preferred embodiment, the floor track T is made of two elongate steel rails running parallel to each other with a space between the rails, each of the rails having a flat top. Such steel rails when used as a floor track T will be extremely durable and sturdy and will allow for the track-mounted pedestals 100 to be repositioned along the length of the floor track T as desired and also temporarily locked and held in place on the tops of the rails during operations. In the preferred embodiment of the track-mounted pedestals 100, the track wheels 60 are steel caster wheels that are located on the bottom portions of the pedestals 100 and placed in contact with the flat tops of the steel floor track T such that the casters allow the track-mounted pedestals 100 to be easily moved to any location along the length of the floor track T when such pedestals 100 are not being held in place in relation to the floor track by the temporary locking means, such as the rod locks 55. In the preferred embodiment, the rod locks 55 are threaded screws or bolts that may be simply tightened down against the top flat surfaces of the floor track's rails in order to make the pedestals 100 virtually immoveable when they are temporarily locked down in a desired position along the length of the floor track T for roof truss assembly operations. As previously disclosed, the preferred embodiment of the track-mounted pedestal 100 also features track guides 65 that are guides or channels that help maintain the track-mounted pedestal 100 on the rails of the floor track T so that it will not derail from the floor track T during movement before or after truss assembly operations.

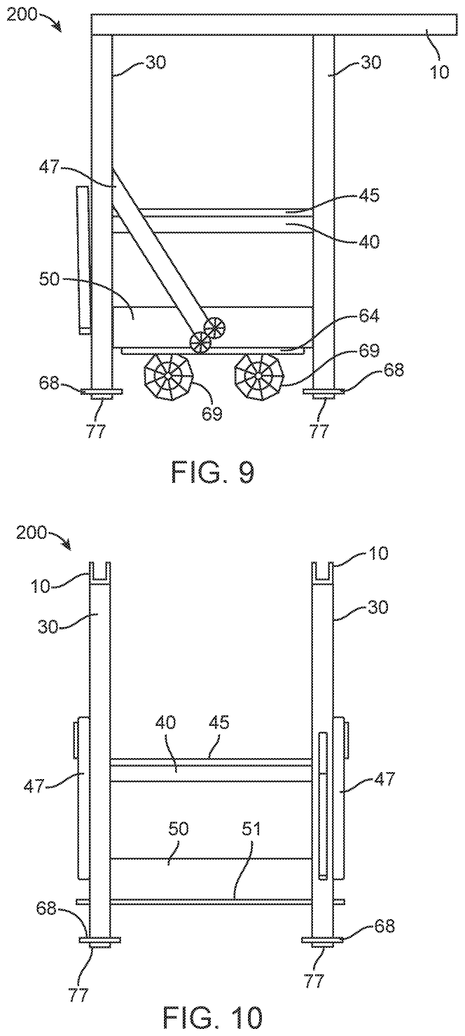

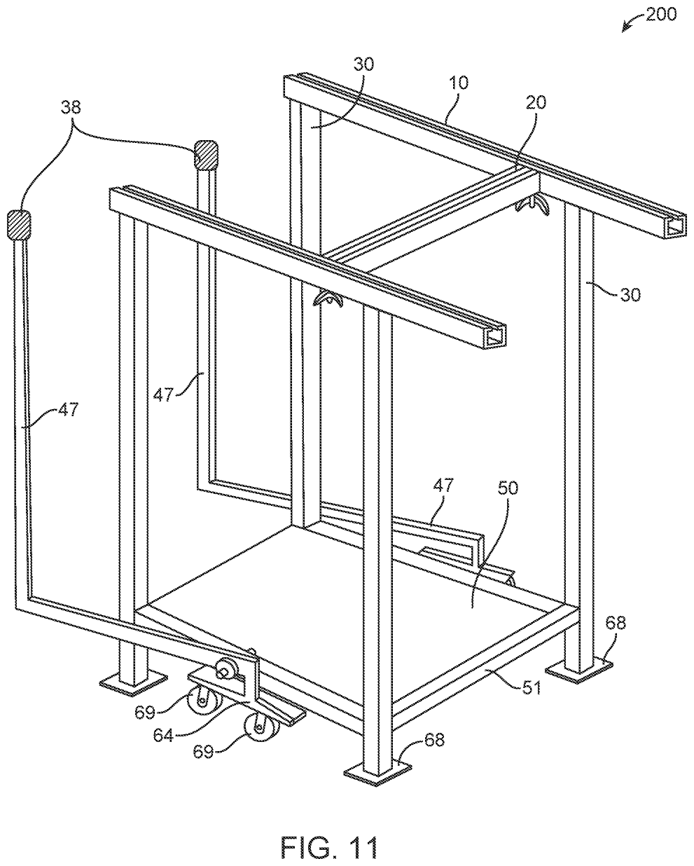

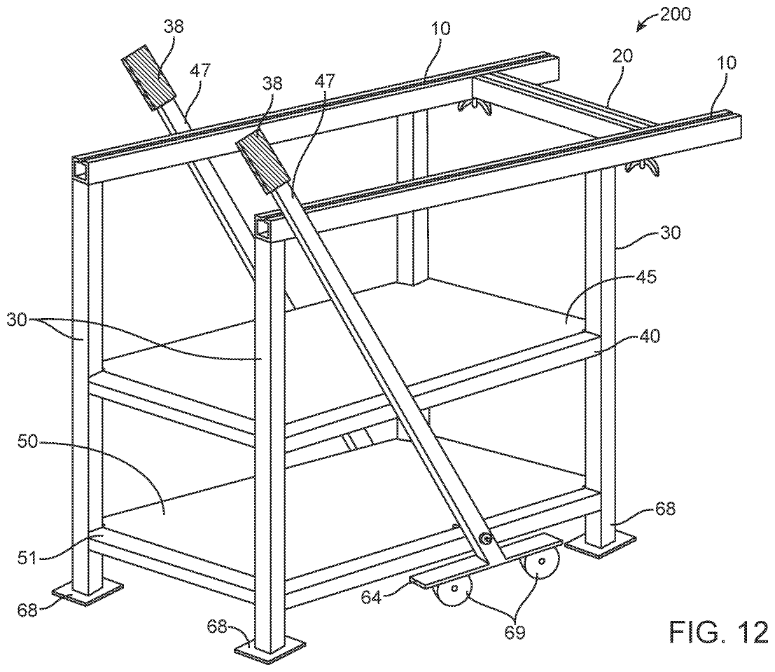

FIGS. 9-12 show embodiments of the independent pedestals 200 that are also a part of the roof truss assembly system. The independent pedestals 200 are similar to the track-mounted pedestals 100 in design in that they also have a basic cart-like body. However, the independent pedestals 200 are not mounted to the floor track T and they are freely moveable in relation to the track T and in relation to the track-mounted pedestals 100. Unlike the track-mounted pedestals 100 that are restricted to linear movement along the floor track T, the independent pedestals 200 may be freely relocated at any position, at least until the time that the independent pedestals 200 are temporarily positioned on the floor at desired locations for truss assembly operations. Like the track-mounted pedestals 100, most embodiments of the independent pedestals 200 will feature two rigid, parallel arm members 10 at the top of the independent pedestal 200 that are both horizontal to the floor, four leg members 30 that extend downward from the arm members 10 toward the floor, a base plate 50 located near the bottom of the independent pedestal 200, and shelf support members 40 and a shelf 45 that are located intermediate of the base plate 50 and the arm members 10, all of whose features and interrelationships are essentially the same as those of the corresponding structures in the track-mounted pedestals 100. Likewise, the independent pedestals 200 will often feature a cross member 20 that is perpendicular to, and repositionable at various locations between, the arm members 10. Various jigs (not illustrated in FIGS. 9-12) may be detachably connected in desired locations on the arm members 10 and cross members 20 of the independent pedestals 200 for subsequent placement and positioning of the chord boards and web boards during truss assembly operations.

Unlike the track-mounted pedestals 100, the independent pedestals 200 will include free movement means, such as wheels, casters, or some type of mobile track driven system, all of which will not be connected to the floor track T and all of which may be lowered or raised in relation to the main body of the independent pedestals 200 such that the movement means may be brought into rolling or similar type of contact with the floor when the independent pedestal 200 is to be moved, or may be removed from contact with the floor when the independent pedestal 200 is positioned in a desired location on the floor of a shop or manufacturing facility. This ability to move the independent pedestals 200 into a desired position and then temporarily hold the independent pedestals 200 in that position in relation to the floor will typically be accomplished by means of an arm lever 47 that will lower or raise the movement means toward or away from contact with the floor, combined with temporary securement means to help secure the independent pedestals 200 in place at a desired position on the floor, such as rubber stoppers placed on the bottom of the independent pedestals 200 that come into contact with the floor when the movement means are raised and thereby taken out of contact with the floor.

As shown in FIGS. 9-12, in some embodiments of the independent pedestal 200, the free movement means discussed above are a pair of floor wheels 60 that are rotatably connected to a floor wheel base 64 that is itself connected to the arm lever 47. The floor wheels 60, floor wheel base 64, and arm lever 47 may have a variety of shapes and configurations, but in all embodiments in which they appear, they constitute a means for lowering or raising the floor wheels 60 in relation to the floor so that the independent pedestal 200 can be moved across the floor. The independent pedestals 200 that have these features will typically have them on each side of the pedestal such that there will be an arm lever 47 pivotably connected to each side of the independent pedestal 200, with each such arm lever 47 also connected to a floor wheel base 64 under which one or more floor wheels 69 are rotatably mounted. The arm levers 47 may feature hand grips 38 at their tops for grasping when the floor wheels 69 are to be manually motivated downward in order to make rolling contact with the floor below or manually motivated upward in order to retract the floor wheels 69 above the level of the floor when the independent pedestal 200 is to remain for some period of time in a desired location on the floor.

As can be understood when viewing FIGS. 9-12, when the independent pedestal 200 has been moved to a location in relation to the stationary track T where it will remain temporarily in that location for truss assembly operations, the hand grips 38 may be grasped in order to pivot the arm levers 47 so that the floor wheel base 64 is raised upward and the attached floor wheels 69 are no longer in contact with the floor below. When this occurs, the four pedestal rests 68 that are located at the bottom of the leg members 30 will be in contact with the floor. The pedestal rests 68 will typically feature rubber stoppers that will cause the independent pedestals 200 to be less likely to move in relation to the floor below during subsequent truss assembly operations.

In a preferred embodiment, the leg members 30 and shelf support members 40 of the independent pedestals 200 are made of heavy-duty square tubes with a solid 4″ thick 24″×24″ steel plate for the base plate. These construction specifications provide the weight needed for stability when the independent pedestal 200 is lowered into position on the floor for manufacturing operations. As discussed above, in the preferred embodiment temporary securement means are provided by rubber feet grips 77 located on the bottoms of the pedestal rests 68 that come into contact with the floor of the shop or manufacturing facility firmly making the independent pedestals 200 very stable when in position for truss assembly operations. Optionally, one of the four rubber feet grips 77 may be made adjustable up or down to potentially take the teeter out of the independent pedestals 200. The preferred embodiment of the independent pedestal 200 makes use of four 5″ rubber tire casters as the floor wheels 69 that are mounted to the floor wheel base 64 located near the bottom of the pedestal, and which may be pushed down by an arm lever 47 on each side which raises the independent pedestal 200 and pulls the rubber feet grips 77 of the pedestal rests 68 away from contact with the floor, thereby allowing the independent pedestal 200 to be moved to any location on the floor desired. Optionally, there is also a handle extension that can be stored on a pin welded to the frame of the pedestal.

The independent pedestals 200 may, but typically will not, feature an attached roller lift and roller assembly actuator 80. The independent pedestals 200 of the preferred embodiment are extremely stable because of their heavy duty construction, and the solid four pedestal rests 68 with rubber feet grips 77 that rest on the floor when they are in position and the movement means are raised out of contact with the floor. The arm levers 47/hand grips 39 system for the movement means allows the independent pedestals to be lifted clear from the floor in order to move them much more easily. There is no need for metal flooring or magnets to hold the independent pedestals 200 in position when they are lowered into contact with the floor and are not being moved.

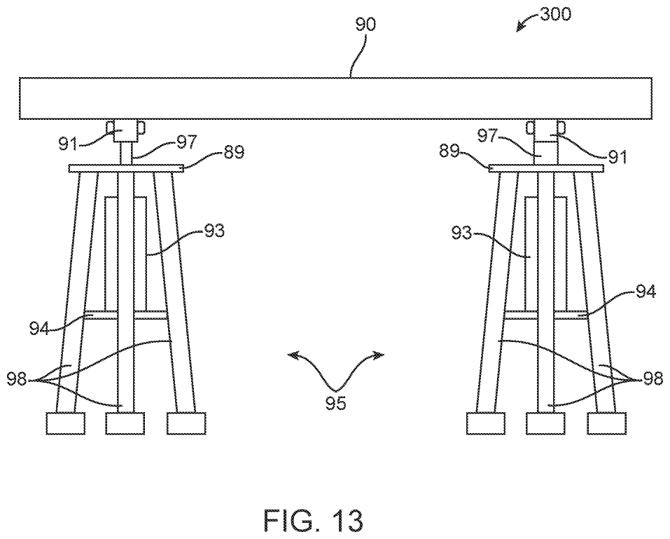

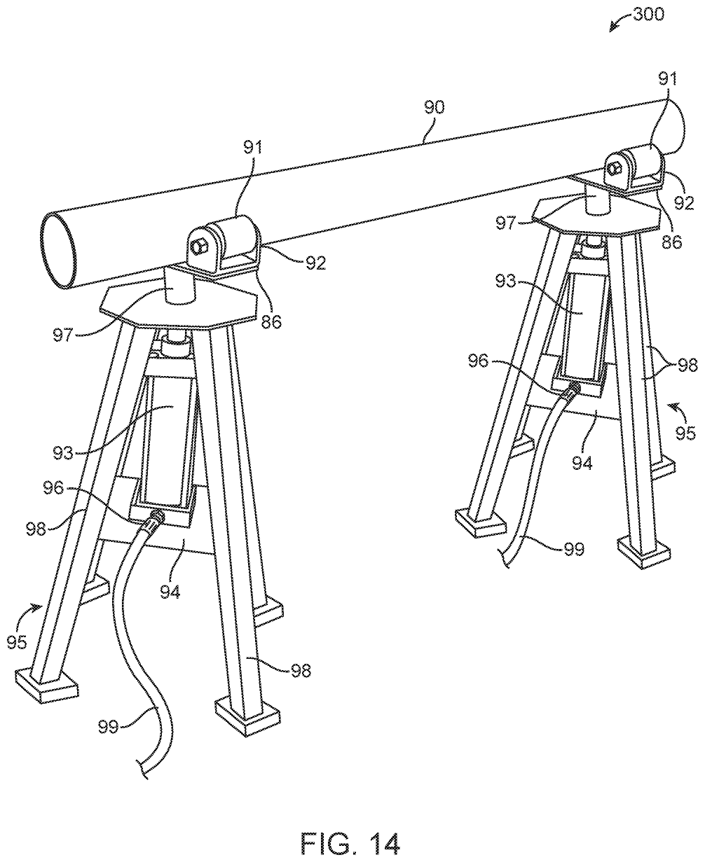

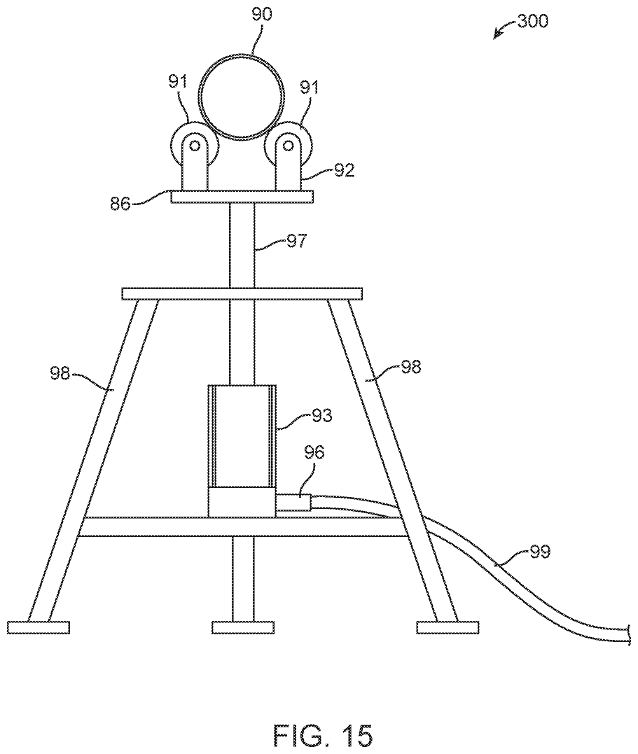

As shown in FIGS. 13-15, the system hereby disclosed will also feature one or more moveable pipe roller assemblies 300 that are, as with the independent pedestals 200, freely repositionable anywhere on the floor and freely repositionable in relation to the other components and subassemblies of the system. The pipe roller assembly 300 is comprised of two tripod support stands 95, each of which features means for raising and lowering a pipe roller 90 in relation to the top of the tripod support stands 95. The pipe roller 90 may be raised by a roller actuator 93 that uses pneumatic, hydraulic, or mechanical actuation means. The pipe roller assembly 300 can be moved anywhere in relation to the independent pedestals 200 or the track-mounted pedestals 100 where the pipe roller assembly 300 may be needed for raising the completed trusses above the arm members 10, cross members 20, and jigs 22 of the moveable pedestals and thereby allowing the completed trusses to be rolled off and moved away from the system for subsequent storage or transport.

As shown in FIGS. 13-15, in a preferred embodiment of the system each pipe roller assembly 300 is comprised of two tripod support stands 95 that provide a stable base to raise the pipe roller 90 that is used to lift a completed truss above the tops of the moveable pedestals 100, 200 and the jigs 22 located thereon, for movement of the completed truss off of and away from the assembly system. Each tripod support stand 95 features three tripod legs 98 that are rigidly connected by both a tripod base plate 94 and a tripod top plate 89. The two tripod support stands 95 of each pipe roller assembly 300 provide a stable base that stands the correct height to work with the roller lifts 70 that are mounted on at least some of the moveable pedestals.

In each pipe roller assembly 300, the pipe roller 90 is rollingly supported by a total of four support rollers 91, with two support rollers 91 being provided by each of the tripod support stands 95. As can be seen in FIGS. 13-15, each of the tripod support stands 95 features a pair of support rollers 91 at its top. In practice, the two tripod support stands 95 of each pipe roller assembly 300 are placed at some desired distance apart from each other. The pipe roller 90 is then laid across the top of each pair of support rollers 91 so that it is rollingly supported above the two tripod support stands 95 by the four support rollers 91. Each pair of support rollers 91 is rotatably mounted within a support roller housing 92 that is attached to the top of a swivel plate 86. The bottom of the swivel plate 86 is, in turn, rigidly connected to the top of a roller lift tube 97. In a preferred embodiment, the swivel plate 86 provides a rotatable connection point between the top of the roller lift tube 97 and the support roller housing 92. The rotatable connection provided by the swivel plate 86 is in the form of multiple ball bearings situated between the top and bottom plates of the swivel plate 86 that allow the top plate of the swivel plate 86 that is rigidly connected to the support roller housing 92 to be spun around as desired for rotational positioning of the support rollers 91 so as to facilitate receiving and rollingly supporting the pipe roller 90 at the top of the tripod support stand 95.

As discussed, the swivel plate 86 of each tripod support stand 95 is rigidly connected on its bottom plate to a roller tube lift 97. The roller tube lift 97 is a vertically oriented tube that may be motivated upward or downward in relation to the tripod support stand 95 by means of a roller actuator 93. The roller actuator 93 may use pneumatic, hydraulic, or mechanical means to move the roller tube lift 97 upwards or downwards. As can be understood, the movement of the roller tube lift 97 upwards will raise the swivel plate 86, the support roller housing 92, the support rollers 91, and the pipe roller 90. This is useful when a completed roof truss needs to be lifted above the arm members 10, cross members 20, and jigs 22 of the moveable pedestals and then slid off the assembly for subsequent storage or transport.

With the ability to lift or lower and also to rotate the support rollers 91 and the pipe roller 90 that they support as desired, the pipe roller assemblies 300 may be positioned at any angle in relation to the other component parts and subassemblies of the system and in relation to a truss being built, which makes them quite useful. Furthermore, in the preferred embodiment of the pipe roller assembly 300, the tripod support stands 95 and their support rollers 91 will accept pipes of any length longer than 24″, which makes the pipe roller assemblies 300 extremely versatile to use for essentially any truss configuration.

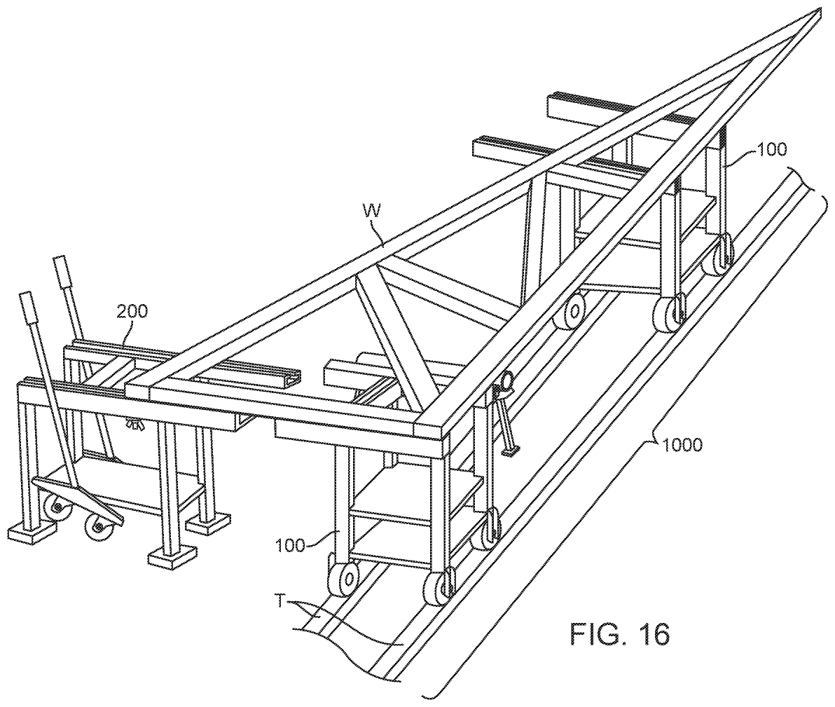

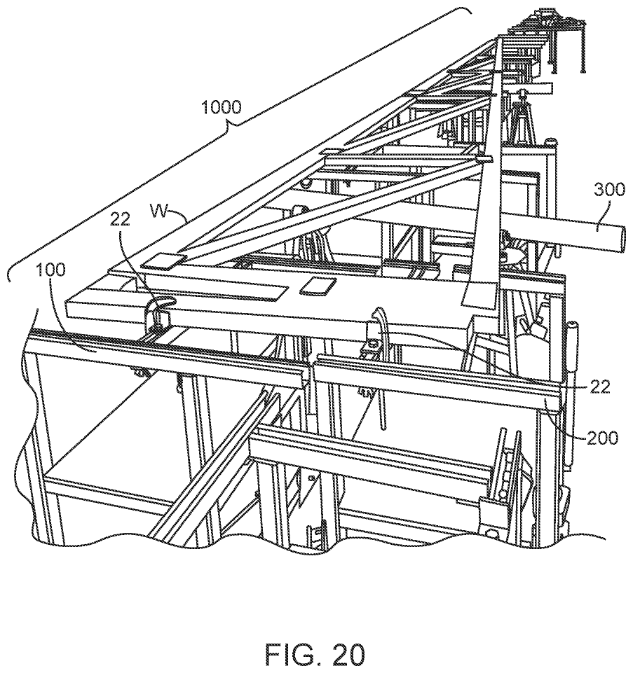

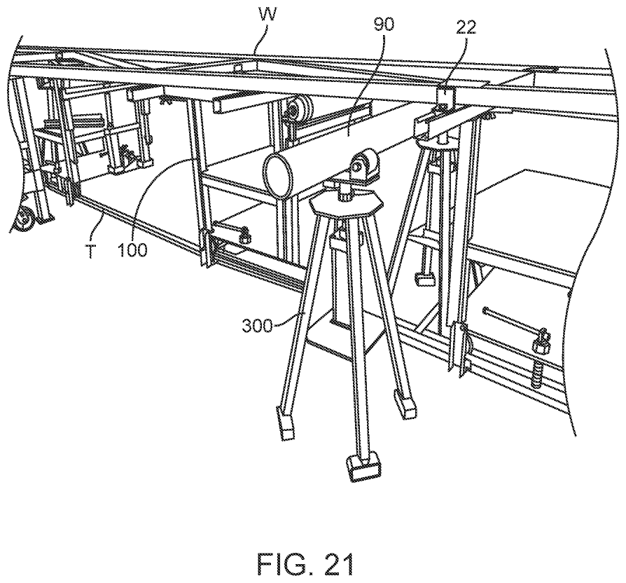

FIGS. 16-23 are intended to illustrate various embodiments of the roof truss assembly system as they might be used during assembly of roof trusses. As shown in FIG. 16, a roof truss W, that is the workpiece of the system, is positioned with its component chord boards and web boards positioned on top of an independent pedestal 200 and also positioned on top of multiple track-mounted pedestals 100 and an underlying floor track T that make up the floor-track subassembly 1000. Though not shown in FIG. 16, the chord and web boards of the truss W would typically be held in a desired alignment by multiple jigs 22 that would be placed at desired locations on the arm members 10 and cross members 20 that are at the tops of the moveable pedestals of the system.

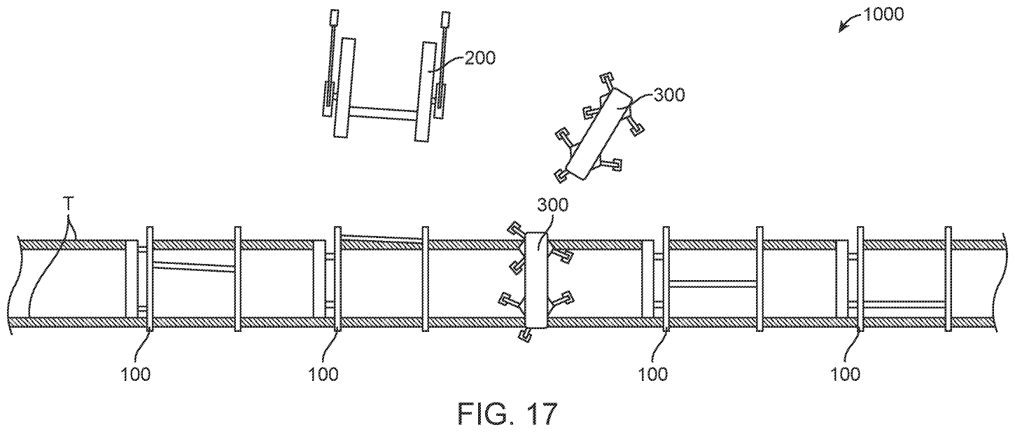

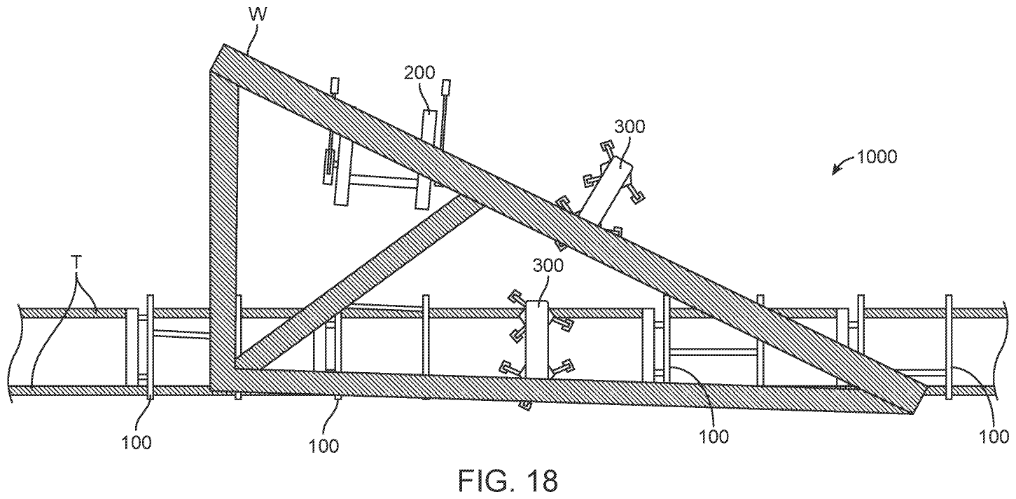

FIG. 17 illustrates an embodiment of the roof truss assembly system as it might appear prior to any placement of chord boards and web boards of a roof truss that is to be constructed. As can be seen in FIG. 17, an embodiment of the system may be comprised of a floor-track subassembly 1000 that is comprised of multiple track-mounted pedestals 100 that are located at desired positions along a floor track T. The system may be further comprised of one or more independent pedestals 200 and one or more pipe roller assemblies 300, all of which may be moved to desired locations in relation to the floor-track subassembly 1000. FIG. 18 shows the same embodiment of the system as illustrated in FIG. 17, but in FIG. 18 the chord boards and web boards of a truss W are illustrated as being positioned on top of the track-mounted pedestals 100, independent pedestals 200, and pipe roller assemblies 300 of the embodiment of the system. As mentioned previously, in practice, the chord boards and web boards would normally be held in a desired geometric arrangement during assembly by multiple repositionable jigs that would be attached to the tops of the moveable pedestals 100, 200 of the system.

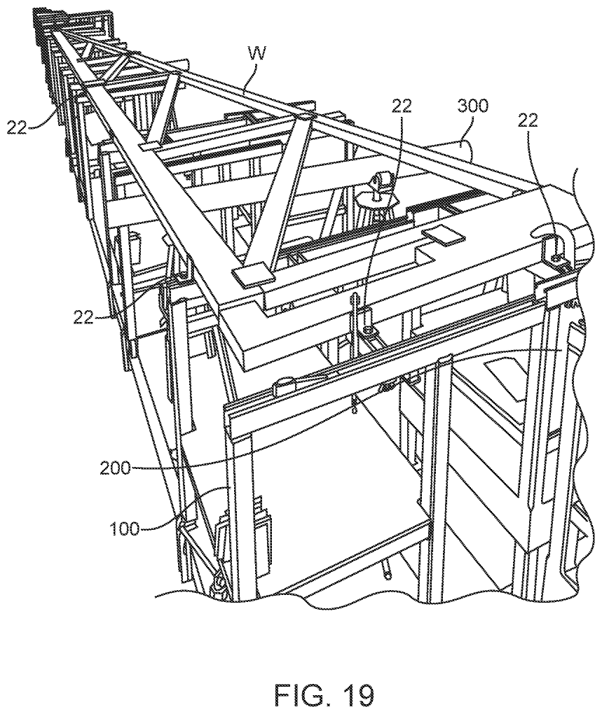

FIGS. 19-21 are additional illustrations of embodiments of the system. As shown in FIGS. 19-21, the system may be comprised of multiple track-mounted pedestals 100 that are in rolling engagement with a stationary floor track T, one or more independent pedestals 200, and one or more pipe roller assemblies 300. As further shown in FIGS. 19-21, the chord boards and web boards of the roof truss W will normally be held in a desired geometric arrangement or alignment by multiple repositionable jigs 22 that are detachably connected at desired locations on the arm members 10 and cross members 20 of the moveable pedestals 100, 200. When the roof truss W is completed, it may be lifted up above the level of the jigs 22 by upward actuation of the roller lifts 70 and pipe rollers 90 of the system, and then the completed truss W may be rolled off of the system by rolling movement of the roller lifts 70 and pipe rollers 90. The completed truss W may then be stored or transported as desired following its assembly.

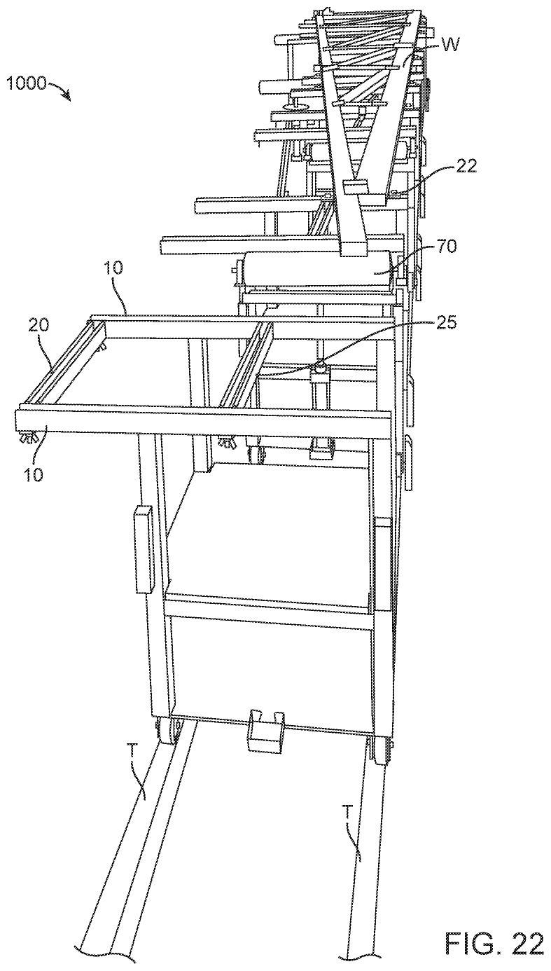

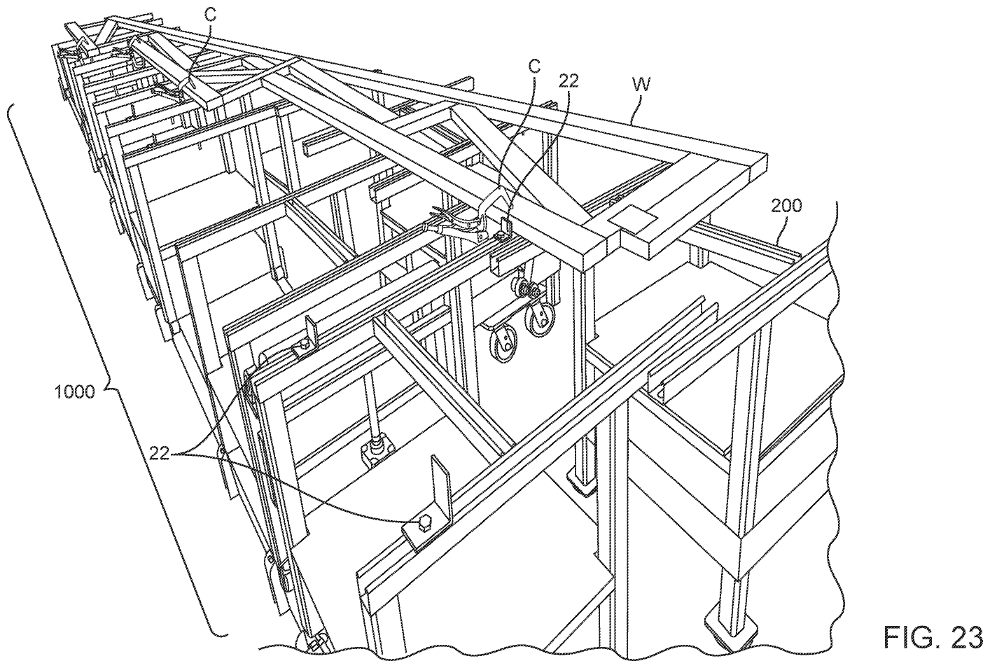

FIGS. 22 and 23 further illustrate embodiments of the system. FIG. 22 shows the floor-track subassembly 1000 with a roof truss W under construction on top of the subassembly 1000. FIG. 23 shows an embodiment of the system in which the floor-track subassembly 1000 and multiple independent pedestals 200 are being used to support the roof truss W. FIG. 23 illustrates that multiple repositionable jigs 22 may be attached at desired locations on the arm members 10 and cross members 20 of the moveable pedestals 100, 200 for use in holding the truss W. Also shown in FIG. 23 are multiple clamps C that may be used for additional securement of the chord boards and web boards of the truss W to the tops of the moveable pedestals 100, 200 during assembly operations.

As discussed above, the upward and downward motivating force for lifting or lowering the roller lifts 70 will be provided by a roller assembly actuator 80 located on the base plate 50 that extends or retracts a roller piston 78. Likewise, the upward and downward motivating force for lifting or lowering the pipe rollers 90 will be provided by a roller actuator 93 located on the tripod base plate 94. As previously explained, the roller assembly actuator 80 and the roller actuator 93 may be pneumatic, hydraulic, or motorized mechanical lifting devices. However, the inventor has determined that the best mode for the raising and lowering of the roller lifts 70 and pipe rollers 90 is accomplished by means of a pneumatically actuated air cylinder situated in an air cylinder housing. Thus, to the extent that the invention has been reduced to practice, the roller assembly actuators 80 and the roller actuators 93 are pneumatically actuated air cylinders situated in air cylinder housings that are rigidly affixed to the respective base plates 50, 94 and feature a respective push rod 78, 97 extending vertically upward from the air cylinder and capable of pushing the roller lifts 70 and pipe rollers 90 upwards, which occurs when the air cylinder is pneumatically actuated. Air supply hoses 83, 99 may be connected to each of the respective pneumatically actuated air cylinders and each such air supply hose 83, 99 may be coupled or decoupled with an air supply line that runs the full length of the floor track T and features multiple connection points. When in use, the pneumatically actuated air cylinders of multiple track-mounted pedestals 100 and pipe roller assemblies 300 may all be used to raise all of the roller lifts 70 and pipe rollers 90 in unison by means of air flowing through the air supply line. This facilitates removal of the completed roof truss W from the top of the assembly system for subsequent storage or transport. The air supply for all of the air cylinders/pistons of the entire system may be controlled by one lever so that the whole completed truss is simultaneously raised by the roller lifts 70 and pipe rollers 90 moving upwards in unison above the pedestals 100, 200 and the jigs 22 for easy ejection/removal of the completed truss from the assembly system.

In a preferred embodiment, each of the moveable pedestals 100, 200 will also feature a mid-level shelf 45 that is positioned between the bottom portion and top portion of each of the pedestals 100, 200. The shelf 45 may be used to store various items such as hammers or, more advantageously, truss plates that will be used to connect the boards of the truss at each joint during manufacturing operations after the boards have been placed into a desired orientation using the repositionable jigs 22 (and possibly clamps C) at the top of the pedestals 100, 200. In a preferred embodiment the shelf will be constructed from plywood and will be positioned at a height that is 30″ off the level of the floor (bottom of the pedestal), which would create a comfortable working position without the need for excessive bending in order to pick up a truss plate for hammering it into place at a joint.

In a preferred embodiment the repositionable jig system for each of the pedestals 100, 200 may be accomplished through an adjustable jig mounting structure comprised of multiple lengths of Unistrut. As is well known, Unistrut is a galvanized steel rail material having a slotted C-channel structure that features evenly spaced, open slots/holes that are disposed at regular intervals through its central web. Using Unistrut for the repositionable jig system's structure allows for jigs 22 in the form of angle iron stops or pucks to be detachably connected at desired locations along the arm members 10, cross members 20, and supplemental cross members 25 that are located at the tops of the pedestals 100, 200 for use in jigging the truss during manufacturing. For this reason, the arm members 10, cross members 20, and supplemental cross members 25 have been primarily illustrated in the drawing figures as being constructed from Unistrut material. In a preferred embodiment, the repositionable jig system, including the arm members 10, cross members 20, and any supplemental cross members 25, is entirely comprised of heavy duty 1.5″ Unistrut that can accept jigs 22 in the form of angle iron stops or pucks that are used to jig the truss during assembly operations, with the angle iron stops or pucks being capable of detachable connection to the arm members 10, cross members 20, and any supplemental cross members 25 for readily repositioning them to hold various chords and web boards of various sizes and orientations in various desired locations and alignments for building various size/shape/geometry roof trusses. As shown, the preferred embodiment repositionable jig system features arm members 10 that are two parallel lengths of Unistrut material that are rigidly affixed to the tops of the leg members 30 of the pedestals 100, 200 and thereby form the top portion of the pedestals 100, 200, and also features a removable Unistrut cross member 20 that can be positioned perpendicular to, and between, the two parallel arm members 10 and detachably attached thereto during manufacturing operations. The Unistrut cross member 20 may be supplemented by one or more supplemental cross members 25 that are also constructed from Unistrut material. The cross members 10 and any supplemental cross members 25 are detachable/removeable and can be attached/connected at any desired location by using detachable attachment/connection means, such as for example, a bolt and wing nut, screws, pins, etc. that may be used to detachably attach each end of the Unistrut cross members 20 or supplemental cross members 25 to the parallel lengths of Unistrut that are the arm members 10. Once the cross member 20 and/or supplemental cross member 25 are detachably attached at each of their respective ends to one of the parallel lengths of Unistrut that are the arm members 10, jigs 22 in the form of angle iron stops or pucks may be detachably attached to the Unistrut arm members 10, cross members 20, and supplemental cross members 25 of the jig system in desired locations, and manufacturing operations may commence.

As discussed above, and as illustrated in some of the figures filed herewith, all of the pedestals 100, 200 of the system feature a repositionable jig system mounted at the top of the pedestals 100, 200. The repositionable jig system will allow for jigs 22 to be placed, removed, and replaced in various positions at the top of the pedestals 100, 200 so that different size and different shaped trusses can be constructed using the system, depending upon where the pedestals 100, 200 and where the jigs 22 atop the pedestals 100, 200 are positioned during manufacturing. The jigs 22 are used for positioning and alignment of the chord boards and the web boards during manufacturing, and the system allows for the jigs 22 to be moved to desired positions on top of the pedestals 100, 200, detachably attached in desired positions, and detached and moved to new, different positions for new detachable attachment in those new, different positions as may be desired for building different size/shape/geometry trusses using the system. In most embodiments the jig system will be comprised of two parallel rails with a multiplicity of evenly spaced positions along the arm members 10 that are two parallel rails for detachable attachment of the jigs 22, such as the Unistrut material discussed above regarding a preferred embodiment, and the system will be further comprised of a removable cross member 20 that can be detachably attached between, and perpendicular to, the two parallel rails, with the cross member 20 also featuring a multiplicity of evenly spaced positions along its length allowing for detachable attachment of jigs 22, and again, in the preferred embodiment this structure and function is achieved by using Unistrut material.

As stated previously, most roof truss assembly systems are large gantry type systems or extremely large stationary tables that require a very large space, not only to install the machine, but to operate it effectively. The roof truss assembly system hereby disclosed can be configured for use in a very small footprint, making it ideal for small to medium size shops and truss plants. It is also versatile, and easy to set up and use, without the extreme expense of an automated jig table type system. The table top working height of the pedestals and the optional middle level shelves also reduces fatigue and helps increase production.

The embodiments and other features, aspects, and advantages of the present invention may be best understood and appreciated with reference to the drawings, descriptions, and claims. Where used in the various figures of the drawings, the same numerals designate the same or similar parts. Furthermore, when the terms “top”, “bottom”, “upward”, “downward”, “linear”, “length”, “forward”, “backward”, “front”, “back”, “distal”, “proximal”, “lateral”, “vertical”, “horizontal”, “central”, “first”, “second”, “third”, “inside”, “internal”, “outside”, “external”, “end”, “side”, “edge” and similar terms are used herein, it should be understood that, unless otherwise specifically stated or otherwise made specifically clear by context, these terms have reference only to the structure shown in the drawings as it would appear to a person viewing the drawings, and such terms are to be utilized in connection with the appended drawings in order to facilitate describing the invention and in order to facilitate a better understanding of the invention.

Although the invention has been described with reference to several specific embodiments, this description is not meant to be construed in a limiting sense. Various modifications of the disclosed embodiments, as well as alternative embodiments of the invention, will be apparent to persons skilled in the art upon reference to the description of the invention. It is, therefore, contemplated that the appended claims will cover such modifications that fall within the scope of the invention.

What I claim is:

1. A roof truss assembly system comprised of:
multiple moveable pedestals featuring locations for detachable connection of at least one jig.

2. The system of claim 1 further comprising:
a linear track comprised of at least one rail that is affixed to the floor of a building;
wherein during truss assembly operations at least one of the moveable pedestals is a track-mounted pedestal that is moveably mounted on the linear track such that the said track-mounted pedestal may be moved to any desired location along the length of the linear track.

3. The system of claim 2 wherein at least one of the pedestals is a freely repositionable pedestal that is freely repositionable to a variety of locations in relation to the linear track such that the freely repositionable pedestal may or may not be in contact with, or in close proximity to, the linear track during truss assembly operations.

4. The system of claim 3 further comprising:
a roller that is a component of at least one of the moveable pedestals;
an actuator that is also a component of at least one of the moveable pedestals;
wherein the roller is rotatably connected to the actuator and wherein the actuator can motivate the roller upward above the remainder of the moveable pedestal and thereby assist with a completed roof truss being moved up and off of the moveable pedestal after truss assembly operations regarding that truss are completed.

5. The system of claim 4 further comprising:
means for temporarily holding a track-mounted pedestal in a desired location along the length of the linear track during truss assembly operations;

6. The system of claim 5 wherein the locations for detachable connection of at least one jig are comprised of a first rigid, elongate structure positioned at the top of the moveable pedestals that features evenly spaced, open slots that are disposed at regular intervals through the first rigid, elongate structure.

7. The system of claim 6 further comprising a second rigid, elongate structure positioned at the top of the moveable pedestals that features evenly spaced, open slots that are disposed at regular intervals through the second rigid, elongate structure, and wherein the second rigid, elongate structure is positioned parallel to the first rigid, elongate structure.

8. The system of claim 7 further comprising a third rigid, elongate structure positioned at the top of the moveable pedestals that features evenly spaced, open slots that are disposed at regular intervals through the third rigid, elongate structure, and wherein the third rigid, elongate structure may be detachably attached on a first end to the first rigid, elongate structure and may also be detachably attached on a second end to the second rigid, elongate structure.

9. The system of claim 8 further comprising:
at least one roller assembly that is independent of the moveable pedestals and the linear track and may be repositioned wherever desired in relation to the linear track, wherein the roller assembly itself is comprised of:
at least one rigid stand;
an actuator that is rigidly attached to the stand;
a roller that is rotatably connected to the actuator;
wherein the actuator can motivate the roller upward above the remainder of the roller assembly and thereby assist with a completed roof truss being moved above and away from the moveable pedestals after truss assembly operations regarding that truss are completed.

10. The system of claim 9 wherein at least one of the moveable pedestals is further comprised of a shelf that is positioned beneath the level of the three rigid, elongate structures.

11. The system of claim 10 wherein at least one of the track-mounted pedestals further comprises at least one wheel at the bottom of the pedestal that is rollingly engaged on top of the at least one rail of the linear track.

12. The system of claim 11 wherein at least one of the track-mounted pedestals further comprises at least one track guide that serves to keep the track-mounted pedestal in moveable contact with the at least one rail of the linear track.

13. A roof truss assembly system comprised of:
a linear track comprised of at least one rail that is affixed to the floor of a building where roof truss assembly operations may occur;
one or more track-mounted moveable tables that are mounted on at least one of rail of the linear track;
one or more independent moveable tables that are not mounted on any rail of the linear track and which may be freely repositioned in relation to the linear track.

14. The system of claim 13 wherein at least one track-mounted moveable table comprises a first rigid, elongate arm member to which jigs may be detachably attached for truss assembly operations;

15. The system of claim 14 wherein the at least one track-mounted moveable table further comprises a second rigid, elongate arm member to which jigs may be detachably attached for truss assembly operations;

16. The system of claim 15 wherein the at least one track-mounted moveable table further comprises a rigid, elongate cross member that is detachably attached on a first end to the first rigid, elongate arm member and on a second end to the second rigid, elongate arm member, and wherein jigs may be detachably attached to the cross member for truss assembly operations;

17. The system of claim 16 wherein the independent moveable table further comprises:
a first rigid, elongate arm member to which jigs may be detachably attached for truss assembly operations;
a second rigid, elongate arm member to which jigs may be detachably attached for truss assembly operations;
a rigid, elongate cross member that is detachably attached on a first end to the first rigid, elongate arm member and on a second end to the second rigid, elongate arm member, and wherein jigs may be detachably attached to the cross member for truss assembly operations.

18. The system of claim 17 further comprising:
a roller lift subassembly attached to at least one of the track-mounted moveable tables that may be used to push a completed truss upward from the main body of the track-mounted moveable table and roll the completed truss off of the track-mounted moveable table;
a pipe roller assembly that may be used to push a completed truss upward above the main body of one or more moveable tables of the system and roll the completed truss away from the moveable tables.

19. The system of claim 18 further comprising:
a shelf rigidly affixed to at least one of the moveable tables that is positioned between the floor and the location of the first rigid, elongate arm member of the moveable table.

20. A system for assembling roof trusses comprised of:
Track-mounted pedestals that are mounted on top of the rails of a stationary floor track and that comprise a top and a bottom portion with the top portion further comprising a repositionable jig system;
Independent pedestals that are not mounted to the rails of the floor track, but which comprise movement means for repositioning the independent pedestals and also further comprise a repositionable jig system at their top;
Pipe roller assemblies that are comprised of a rotatable pipe roller and also comprise a means for raising or lowering the pipe roller in relation to the repositionable jig systems at the tops of the track-mounted pedestals and the moveable pedestals;
Wherein the track-mounted pedestals also comprise a roller lift that may be raised or lowered in relation to the repositionable jig systems at the tops of the track mounted pedestals and the movable pedestals.
